(19) United States
(12) Patent Application Publication
(10) Pub. No.: US 2019/0140401 A1
(43) Pub. Date: May 9, 2019

(54) CABLE CONNECTOR WITH SHIELD

(71) Applicant: Molex, LLC, Lisle, IL (US)

(72) Inventors: Bradley HENRY, Little Rock, AR (US); Darian SCHULZ, Little Rock, AR (US)

(73) Assignee: Molex, LLC, Lisle, IL (US)

(21) Appl. No.: 16/095,625

(22) PCT Filed: May 2, 2017
(86) PCT No.: PCT/US17/30584

§ 371 Date: Oct. 22, 2018

Related U.S. Application Data
(60) Provisional application No. 62/331,167, filed on May 3, 2016.

(51) Int. Cl. H01R 13/6581; H01R 13/6466; H01R 13/6469; H01R 24/60

(52) U.S. Cl. CPC H01R 13/6581; H01R 24/60; H01R 13/6469; H01R 13/6466

(57) ABSTRACT

The present disclosure provides a cable connector assembly. The cable connector assembly includes a housing configured to support a frame. The frame having twin-ax cables and ground conductors insert molded therein. The frame further includes a pocket with a portion of the cables and ground conductors exposed. The cable is dressed so that the inner shielding layer is accessible within the pocket. A conductive fill material is disposed in the pocket that connects the shielding layer to the ground conductors. A printed has circuit board a mating end and a securing end and is secured to the frame and configured to engage electrical terminals of a mating connector. Contact pads are formed on the securing end and the signal conductor of the cable and the ground conductors are respectively soldered to appropriate pads on the circuit board.

### RELATED APPLICATIONS

This application claims priority to U.S. Provisional Application No. 62/331,167, filed on May 3, 2016 which is incorporated herein by reference in its entirety.

### TECHNICAL FIELD

The current disclosure relates to the field of cable connectors more specifically to field of cable connectors with a shield.

### DESCRIPTION OF RELATED ART

The current disclosure relates to a grounding structure of an electrical connector suitable for high frequency transmitting. The high frequency connector has a connecting part including a printed circuit board being combined with a cable management section. Typically, a twin axial cable is constructed with a pair of signal conductors surrounded by an insulator, a drain wire adjacent the insulators and a surrounding conductive shielding foil or mesh. The entire cable is enclosed in an insulative jacket.

Typically, a cable connector includes a housing having a mating end and a cable mounting end. The housing supports the cable and a printed circuit board positioned at the mating end. The cable extends through the housing with exposed conductors mounted to conductive pads formed on the circuit board. Current products use a standard printed circuit board (PCB) where the back edge of the board stops at the location where the twin axial cable (twin-ax) are soldered to the board. In this construction, all the layers and ground planes of the circuit board share the same X and Y dimensions. The foil on the twin-ax is also removed exposing the insulation and the wire.

Due to the location of the edge of the PCB and associated ground planes and the exposed portion of the twin-ax, a region is defined between the edge of the circuit board and the exposed portion of the cable wherein the crosstalk is very high between adjacent twin-ax cables in a vertical and horizontal direction. This crosstalk degrades the performance of the mated cable assembly. The stripped dielectric also causes impedance in the strip region to spike, causing reflections in high-frequency signals which are detrimental to cable function.

Accordingly, certain individuals would therefore appreciate a cable connector with improved shielding at the connection interface of the cables to the printed circuit.

### BRIEF SUMMARY

A cable connector includes a housing having a frame. The frame includes a mounting portion for attaching a print circuit board at a first end and a cable entrance portion at a second end. A twin axial cable is attached to the frame with an exposed portion of the twin axial cable end extending from the first end. The frame includes a pocket formed therein defined between the first end and the second end. The cable extends through the pocket with corresponding bare signal wires extending from the frame.

The cable portion extending through the pocket has a portion of the cable dressed so that has the drain wire and the foil shield is exposed within the pocket. A ground terminal extends through the pocket and exits the first end of the frame. The exposed bare signal wire portions and the ground terminals that extend form the first end of the frame are conductively attached to the contact pads formed on the printed circuit board. A conductive epoxy or conductive fill material is dispensed in the pocket to common or connect the ground terminal with the foil and the drain wire forming a shield.

### BRIEF DESCRIPTION OF THE DRAWINGS

The present disclosure is illustrated by way of example, and not limited, in the accompanying figures in which like reference numerals indicate similar elements and in which:

FIG. 1 is a perspective view of the cable connector of the present disclosure;

FIG. 2 is an alternative perspective of the cable connector of FIG. 1;

FIG. 3 is perspective view of the unmated cable connector of FIG. 1;

FIG. 4 is an unmated view of the cable connector of FIG. 2;

FIG. 5 is an exploded view of the first connector of the cable connector of FIG. 1;

FIG. 6 is a reverse perspective of the first connector of FIG. 5;

FIG. 7 is perspective view of the frame portion of the connector of FIG. 5;

FIG. 8 is a reverse perspective view of the frame of FIG. 7;

FIG. 9 is a plan view of the frame of FIGS. 7; and

FIG. 10 is a view depicting the prior art.

### DETAILED DESCRIPTION

The appended figures illustrate an embodiment of the cable connector and it is to be understood that the disclosed embodiments are merely exemplary and may be embodied in various forms. Therefore, specific details disclosed herein are not to be interpreted as limiting, but merely as a basis for the claims and as a representative basis for teaching one skilled in the art to variously employ the present disclosure. It should further be noted that the depicted embodiments are shown in a variety of configurations that include certain features. Unless otherwise noted, the features can be separated and combined to provide other combinations, which are not shown for purposes of brevity, and therefore the depicted combinations are not intended to be limiting.

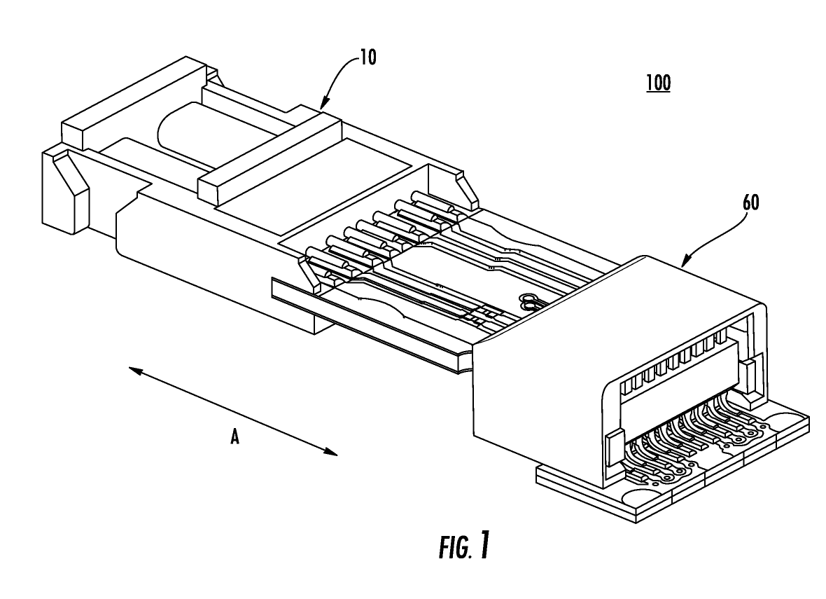

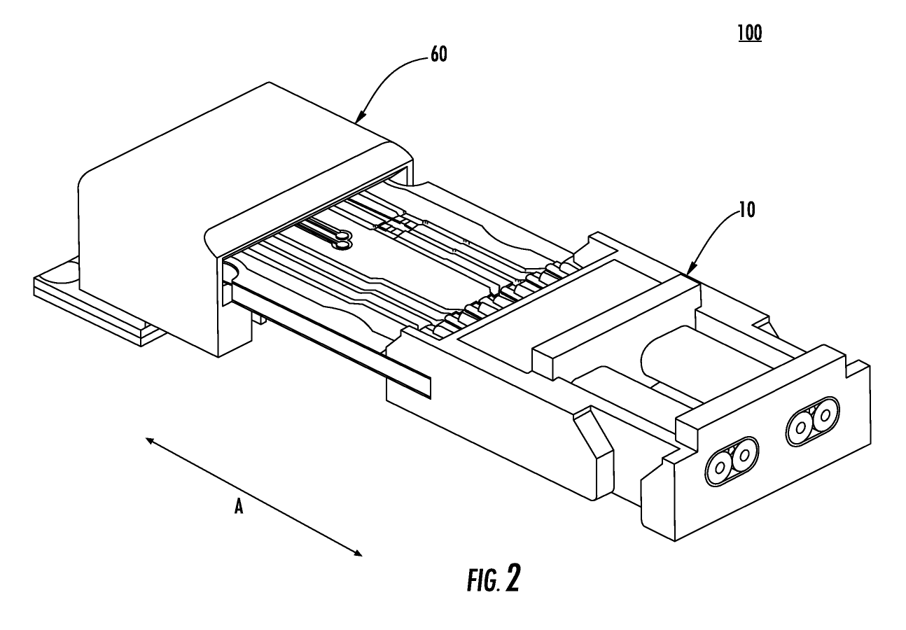

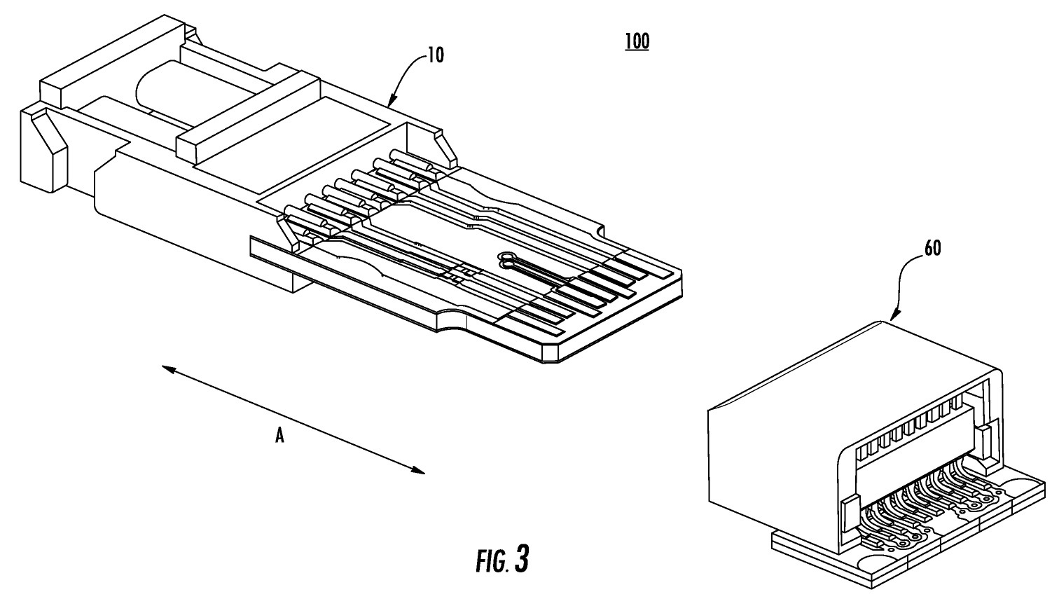

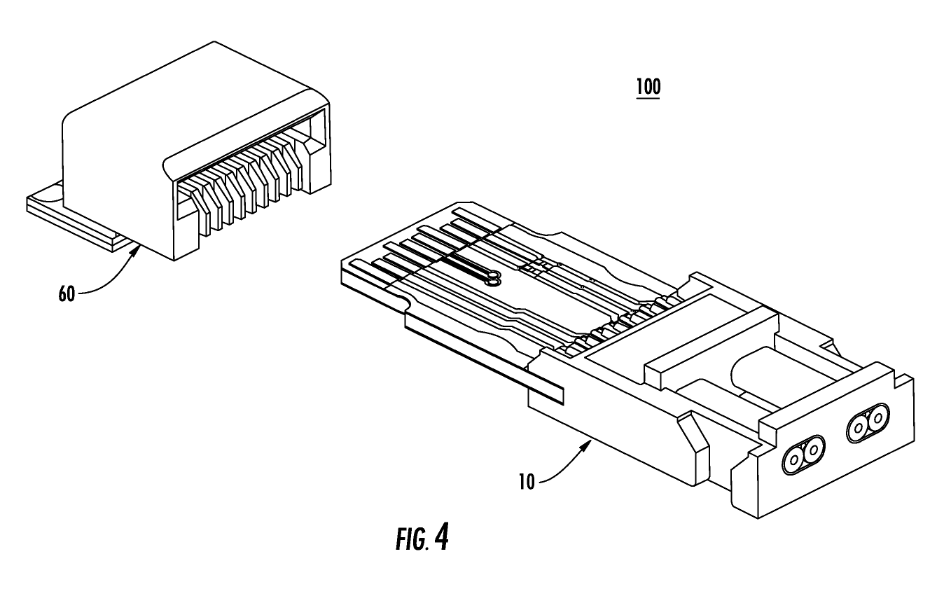

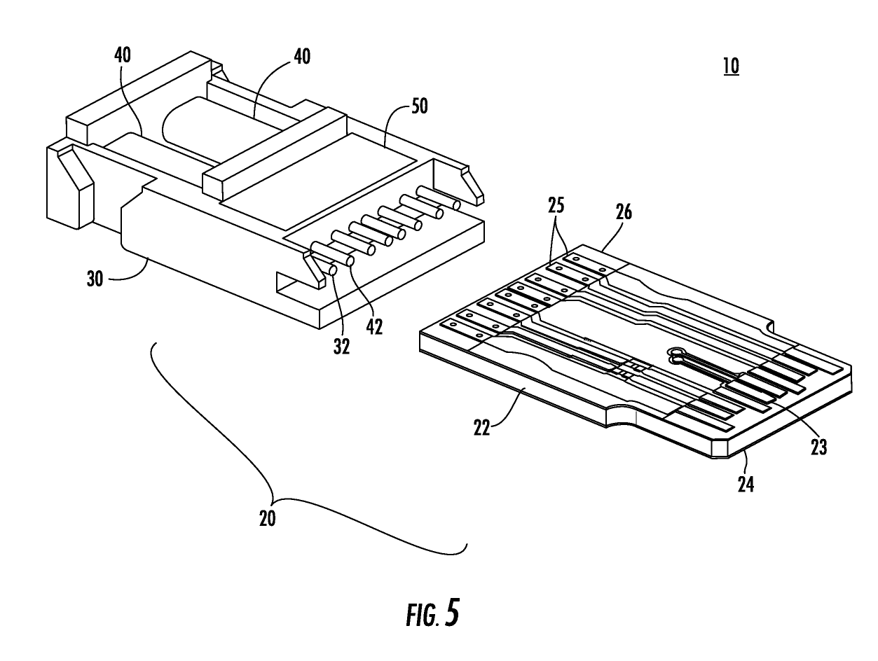

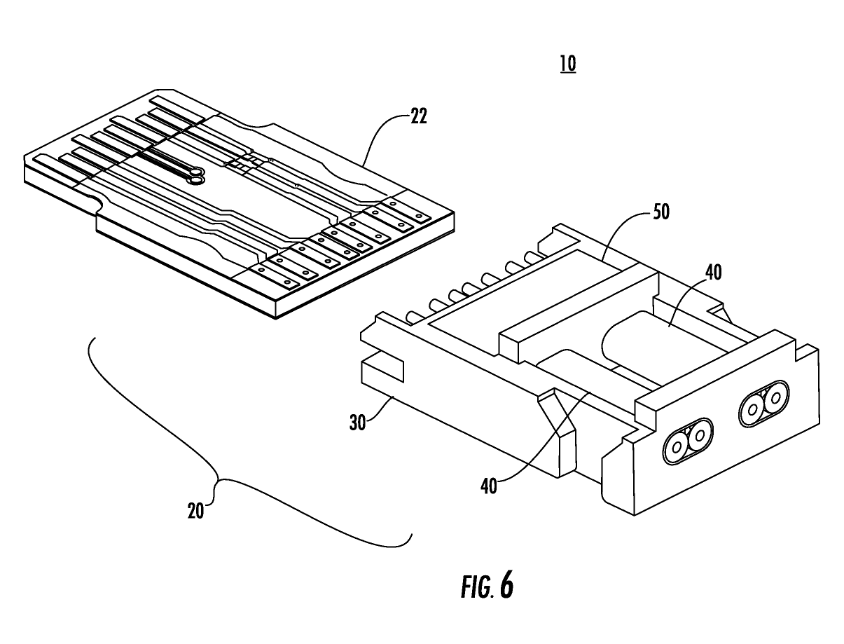

As depicted in FIGS. 1-4, an embodiment of a cable connector assembly 10 includes a first connector 20 configured to mate with a second connector 60 along a mating direction A. As best shown in FIGS. 5-6 the first connector 20 includes a housing (not shown) having a mating end and a cable end. The first connector further includes a connector sub assembly having a frame 30, a printed circuit board 22 and a cable 40 cooperatively connected together and held within the housing.

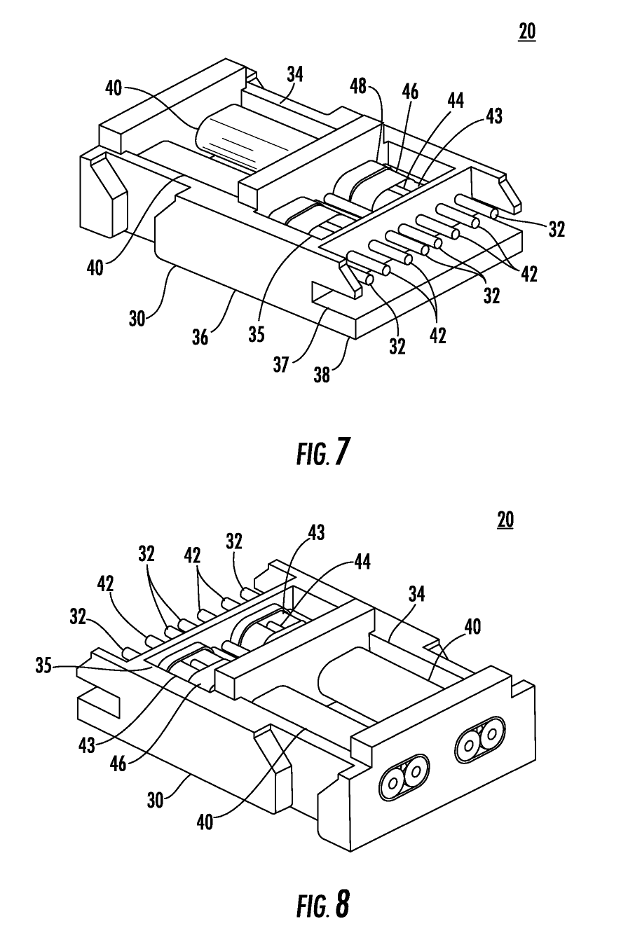

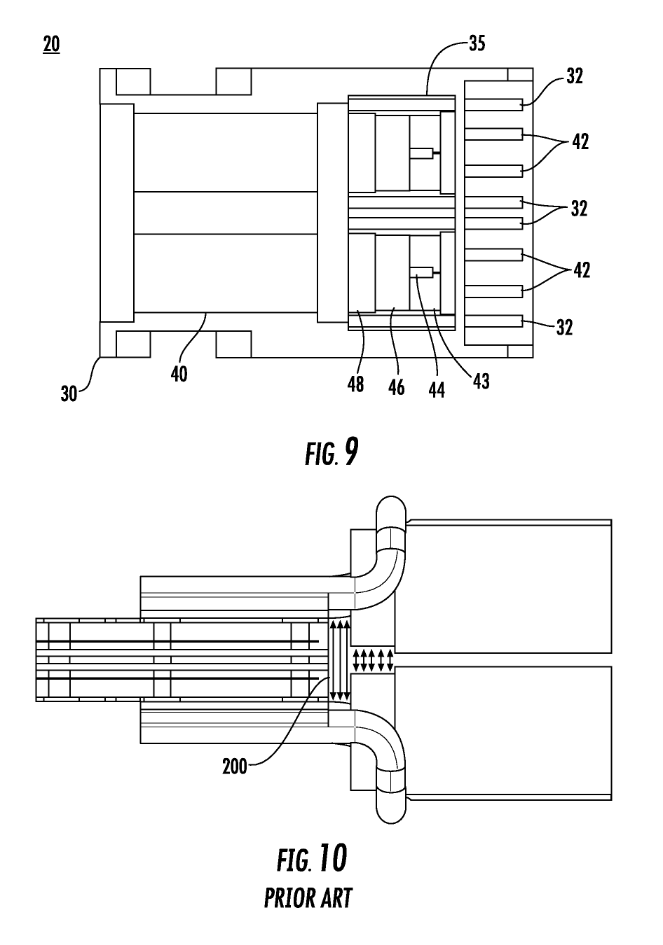

As illustrated in FIGS. 7-9 the cable 40 in the embodiment shown is a typical twin axial (twin-ax) style cable, including a pair of signal wires 42 each having a surrounding insulator 43, a ground return element such as a drain wire 44 arranged adjacent the signal wires or a shielding layer 46 surrounding the signal 42 and drain wire 44 and an external insulative jacket 48 enclosing the entire cable 40. In some instances the cable may include the drain wire 44 and not the shielding layer 46 or include the shielding layer 46 and not the drain wire 44. Another possible construction would be a cable 40 that includes both the drain wire 44 and the shielding layer 46. The shielding layer 46 is typically a conductive foil or braid. The embodiment shows a twin-ax cable but other differential cables may be used as an alternative

A frame 30 is formed from an insulative material and includes a cable mounting section 34, a conductor mounting section 38 and an intermediate section 36 positioned between the cable mounting section 34 and the conductor mounting section 38. The intermediate section includes a pocket 35 formed therein. The conductor mounting portion 38 includes a notch 37 formed in the frame 30 for cooperatively engaging a portion of the printed circuit board 22 for securing and aligning the printed circuit board 22 to the frame 30 and the housing.

The printed circuit board 22 as shown in FIGS. 5-6 includes a mating end 24 configured to connect to a second connector 60 and a conductor securing end 26 adapted to engage conductors of a cable 40. The conductor securing end 26 is also configured to engage the notches 37 formed in the frame 30. The printed circuit board 22 has a plurality of contact pads 23 formed adjacent the mating end 24 of the circuit board 22 for engaging terminals (not shown) in the second connector 60. The contact pads 23 include conductive areas for signal and ground assignments. A plurality of second contact pads 25 are formed on the conductor securing end 26 opposite mating end 24 of the circuit board 22 for electrically connecting to the respective conductors 42 of the cable 40. The leading ends of the conductors 42 are typically soldered to the pads but can be soldered, welded or bonded to the pads 25.

The first 20 connector is constructed by first dressing the individual cables 40. This is accomplished by removing a portion of the outer jacket 48 and exposing the shielding layer 46. Subsequently, a portion of the shielding layer 46 is removed as well which exposes each of the signal wires 43 and the drain wire 44. The shielding layer 46 is generally a foil that can have an outer or inner facing conductive side. In the event of an inward facing conductive side, the foil is dressed by folding the foil back over the jacket 48 exposing the conductive side of the foil. In the embodiment shown, the foil is the type having an outer facing conductive layer. After the foil is dressed, the drain wire 44 and the signal wires 43 remain exposed. The drain wire 44 is cut back from the front of the cable 40 or can be bent rearward positioning it away from the front mating end of the signal wires 43. Each signal wire 43 has a conductor 42 surrounded by an insulator with a portion of each of its respective insulating layer stripped exposing a bare signal wire 42 of the signal conductor 43. Essentially, all of the constructive layers of the cable 40 are exposed, in a generally stepped down relationship.

Once the cable 40 is dressed, the frame 30 and the dressed cable 40 are integrally formed together or insert molded. In this step, a portion of the cable 40, namely, the dressed portion is disposed or inserted in the mold and the frame 30 is then molded or formed around the cable 40. As shown in FIGS. 7-9, the frame 30 includes a cable mounting section 34 where the cable 40 is attached to the frame 30, a conductor mounting section 38 where the stripped bare signal wire 42 extend beyond the frame 30 toward the printed circuit board 22. The printed circuit board 22 is aligned with the notches 37 and secured to the frame 30 with the intermediate section 36 disposed between the cable mounting section 34 and the conductor mounting section 38. The intermediate section 36 further includes a pocket 35 that is recessed in the frame 30 in which the dressed portion of each cable 40 is positioned after the insert molding process. Each portion of the dressed cable 40, for example, the foil 46 and the drain wire 44 are accessible and exposed within the pocket 35. Additionally, ground terminals 32 are also formed with the frame 30. The ground terminals can also be insert molded within the frame 30 or stitched in place. The ground terminal 32 includes a portion within the pocket 35 and a portion that extends beyond the front portion of the frame 30 toward the conductor securing end 26 of the printed circuit board 22. The bare signal wires 42 of the cable 40 are not exposed in the pocket 35 but extend beyond the front portion of the frame 30 similar to the ground terminals 32.

At the conductor mounting section 38 of the frame 30, the bare signal wires 42 of each cable 40 and the around terminals 32 extend outwardly from the frame 30. In the current embodiment, the signal conductors 42 and the ground conductors 32 form a G-S-S-G-G-S-S-G arrangement along a row at the conductor mounting section 38 of the frame 30. A notch 37 is formed on each side of the frame 30 that captures a portion of the printed circuit board 22 and positons the printed circuit board 22 with respect to the frame 30. The bare signal conductors 42 and the ground terminals 32 are then secured to respective contact pads 25 on the adjacent conductor securing end 26 of the circuit board 22. In the embodiment shown, the conductors 42 and ground terminals 32 are soldered to the pads 25. Other securing options are contemplated such as welding and boding.

As previously described, the dressed cables 40 and the ground terminals 32 are exposed in the pocket 35, after which a conductive epoxy or other hardening conductive till material 50 is disposed in the pocket 35. The conductive fill can also be a curable material that is dispensed prior to curing that fills and surrounds the dressed cable 40 and ground conductors 32 exposed in the pocket 35. Upon cure, the conductive fill material 50 makes an electrical connection between all exposed conductive elements exposed in the pocket 50. This essentially connects conductive shielding layer 46, the drain wires 44 of each cable 40 and the ground terminals 32 together commoning them together and creating a shield.

With this arrangement, the maximum amount of intimate contact can be made between the ground conductors 32, the drain wire 44 and the shielding layer 46 as opposed to conventional connecting methods such as simply crimping components together. Crimping only creates contact to the connected components in the crimped or attachment area only. This improvement addresses the signal integrity issues with stripped twin-ax cable (cross-talk and impedance discontinuity) by extending the shield through conductive fill. The ground reference is passed to the PCB through the ground wires is also captured by the conductive fill. As best illustrated in FIG. 10, which is a depiction of similar arrangements of the prior art, the area 200, shows the lack of a ground plane and the exposed twin-ax dielectric results in increased crosstalk and an impedance discontinuity. Both of these degrade cable assembly performance at high frequencies.

Additional mechanical benefits are also realized. A more liberal strip length is allowable from the end of the cable, due to the added connection strength provided by the conductive fill shield extension. This essentially creates an added strain relief that connects the body of the cable to the frame, so external forces can be redirected away from the signal wire to printed circuit board connection. Twin-ax cables may be positioned “drain-up” or “drain-down” because the drain wire is completely captured by the conductive fill; the ground reference is passed through the conductive fill shield to the PCB. The mechanical benefits should also allow for easier implementation of an automated assembly process and improved strain relief.

Once this step is complete, an optional molding operation encapsulates the entire assembly securing the assembly together. The assembly is disposed in a housing that is formed from a conductive material such as die cast aluminum. Other materials such as plastic is also contemplated for the housing. An optional latching mechanism including a locking member and pull member are movably attached to the housing that al lows the cable connector to be securely locked to the receptacle connector or cage where the receptacle is placed.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

What is claimed is:

1. A connector comprising:
a housing;
a housing sub-assembly including a frame, the frame includes a mounting section and a securing section, an intermediate section formed between the mounting section and the securing section, a pocket formed in the intermediate section;
a cable, the cable including a signal conductor having an insulator and a ground return element, the cable secured to the frame;
a ground conductor, the ground conductor secured to the frame;
a circuit board, the circuit board mounted to the frame, the circuit board including conductive pads, each signal conductor and the ground conductor secured to respective conductive pads; and
a conductive material disposed in the pocket.

2. The connector of claim 1, wherein the cable is a twin-ax cable.

3. The connector of claim 2, wherein the ground return element is a shielding layer.

4. The connector of claim 3, wherein the shielding layer is a conductive foil.

5. The connector of claim 2, wherein the ground return element is a drain wire.

6. The connector of claim 1, wherein the conductive material is a curable resin.

7. The connector of claim 1, wherein the cables are insert molded with the frame.

8. The connector of claim 1, wherein the ground conductor is insert molded with the frame.

9. The connector of claim 1, wherein the signal conductor and the ground conductor are soldered to the printed circuit board.

10. The connector sub-assembly comprising:
a frame, the frame having a pocket;
a cable, the cable including a signal conductor having an insulator and a ground return element, the cable secured to the frame;
a ground conductor secured in the frame;
a conductive material disposed in the pocket; and
wherein an exposed portion of the ground return element and the ground terminal are connected together by the conductive material.

11. The connector sub-assembly of claim 10, where a printed circuit board is secured to the frame.

12. The connector sub-assembly of claim 11, wherein the signal conductor and the ground conductor are soldered to the printed circuit board.

13. The connector sub-assembly of claim 10, wherein the ground return element is a drain wire.

14. The connector sub-assembly of claim 10, wherein the ground return element is a conductive foil.

15. The connector sub-assembly of claim 10, wherein the cable is a twin-ax cable.

16. The connector sub-assembly of claim 10, wherein the cable and the ground conductor are insert molded in the frame.

17. The connector sub-assembly of claim 10, wherein the conductive material is a curable resin.

18. The method for producing a connector comprising:
providing a cable, the cable including a signal conductor, the signal conductor having an insulator surrounding the signal conductor and a ground return element;
dressing the cable whereby a portion of the ground return element and the signal conductor are exposed;
providing a ground conductor;
molding a frame over the cable and the ground conductor, a pocket is formed in the frame that exposes a portion of the ground return element of the cable and the ground conductor;
inserting a conductive material into the pocket that connects the ground return element to the ground conductor;
securing a printed circuit board to the frame and connecting the signal conductor and the ground conductor to the printed circuit board; and
supporting the frame by a housing.

19. The method for producing a connector of claim 18, wherein securing the signal conductor and ground conductor is accomplished by soldering.

20. The method for producing a connector of claim 18, further comprising curing the conductive material.
